(19) United States
(12) Patent Application Publication
(10) Pub. No.: US 2010/0064077 A1
(43) Pub. Date: Mar. 11, 2010

(54) Method of defining shortcut key of input device

(75) Inventor: Kuei-Lin Chung, Taipei (TW)

Correspondence Address: BACON & THOMAS, PLLC, 625 SLATERS LANE, FOURTH FLOOR, ALEXANDRIA, VA, 22314-1176, US

(73) Assignee: KUEI-LIN CHUNG, Taipei (TW)

(21) Appl. No.: 12/379,013

(22) Filed: Feb. 11, 2009

(30) Foreign Application Priority Data
Sep. 9, 2008 (TW) 097134616

(51) Int. Cl. G06F 13/12

(52) U.S. Cl. 710/67

(57) ABSTRACT

The present invention discloses a method of defining the shortcut key of input device. When a computer system with a central processor is implemented, this method presets several shortcut key TABLEs, each of which corresponds to an application; every TABLE is predefined with a user-defined key and corresponding shortcut key's analog code; the shortcut key TABLE is loaded into the system simultaneously with the corresponding application; when the user-defined key entered by the user is converted into internal code by BIOS, the central processor outputs the corresponding shortcut key's analog code into the application according to the shortcut key TABLE; in such case, the application can enter the corresponding command and generate action accordingly, thus improving the compilation efficiency of the user according to the users' operating practices.

### FIELD OF THE INVENTION

The present invention relates generally to a method of defining the shortcut key of input device, and more particularly to an innovative one which is customized to define the shortcut key of input device according to the users' operating practices.

### BACKGROUND OF THE INVENTION

In a computer framework, the keyboard and mouse input devices play a crucial role in the interaction with the system. Referring to FIG. 1, any individual with computer knowledge can understand how to operate the keyboard and computer system through the following steps:

Step 1: when a user presses any key on the keyboard, an electric circuit in the keyboard generates a signal specific to the key (different signals are defined by the keys on the keyboard);

Step 2: when the aforementioned signals are detected by the microprocessor on the keyboard, a corresponding scan code will be generated and then stored temporarily in the buffer zone of the mainboard;

Step 3: BIOS on the mainboard reads positively the scan code, converts into a corresponding internal code, and stores in RAM for data processing by the central processor;

Step 4: the central processor reads the internal code, and implements the character functions specific to the internal code (implementation behavior or character displayed on the screen).

As shown, any signal generated by pressing a key will be finally converted by BIOS into a specific internal code; the English coding modes in the keyboard previously included: ASCII, ISO8859 or EBCDIC, while Chinese coding mode included BIG5. Up to now, various languages in IT industry are integrated into UNICODE code.

The internal code is aimed at converting the identifiable characters into binary codes that can be accessed by central processor (shown in FIG. 2), e.g.: if pressing SPACE button, BIOS will convert the characters into U+0020; after being accessed and identified by the central processor CPU, an empty character string will be generated on the screen; if pressing numeric key 0, BIOS will convert them into U+0030; after being accessed and identified by the central processor, a character 0 will be generated on the screen.

As for the graphic characters of UNICODE code, a character symbol will be generated at the cursor point after entry; in addition, a control character is also defined for UNICODE code. The difference between the control character and graphic character lies in: the control character is not displayed on the screen, but the computer is controlled to implement a certain action or command, for example: shift of direction key, DEL or ESC; as aforementioned keys are converted by BIOS according to UNICODE code, the worldwide keyboards are provided with keys that can generate control characters.

With rapid development and integration of applications, the defined control characters of previous keyboard could not answer the complex requirements of most of the applications. Today, the designed applications are defined with the shortcut key that enables the users to operate the programs conveniently with self-developed behaviors or functions;

Shortcut keys means pressing function keys (e.g.: CTRL, SHIFT or FN) in collaboration with other keys could control the window or implement a specific behavior similar to the functions of control character; these keys are mainly defined in applications in the same manner as the central processor and keyboard; the applications with shortcut key functions shall be provided with a shortcut key T, which is loaded into the computer system simultaneously with the application; when a user presses down the shortcut key, such a key will generate scan code, which is compiled by BIOS into UNICODE code and accessed by the central processor. In such case, the central processor outputs the command corresponding to the shortcut key TABLE preset by the application, for example: if pressing Ctrl+N in the EXCEL application, the command of new files will be generated by the coding procedure and shortcut key TABLE, so the user likely memorizes the common functions or the activated shortcut keys for intended quick entry and utilization.

Despite that the shortcut keys permits to operate the applications and compile the files easily, these keys are mainly defined by the program developers, and subject to many restrictions, e.g.: use in collaboration with function keys (CTRL, SHIFT or FN); in other words, the shortcut keys are operated by pressing manually two or more keys. When the shortcut keys are to be modified or added, the user has to modify the shortcut key TABLE in sequence according to the provisions of every application.

In view of the shortcomings of the present existing storage devices with an inconvenient way of expanding their storage capacity, the inventor of the present invention based on years of experience in the related industry to conduct extensive researches and experiments, and finally developed a dynamic, convenient, safe and efficient way of expanding the storage capacity to overcome the shortcomings of the prior art.

### SUMMARY OF THE INVENTION

The primary objective of the present invention is to provide a method of defining the shortcut key of input device, which enables the user to define the shortcut key at its own discretion according to the operating practices. Such a method is implemented in a computer system with central processor. According to this method, some shortcut key TABLEs are predefined, each of which corresponds to an application; moreover, every TABLE is predefined with a user-defined key and corresponding shortcut key's analog code. This method comprises the following steps:

Step 1: the shortcut key TABLE is loaded into the system simultaneously with the executable program files;

Step 2: the user-defined key entered by the user is converted into internal code by BIOS; according to the loaded shortcut key TABLE, the central processor outputs the corresponding shortcut key's analog code into the application;

Step 3: the application enters the corresponding command and generates action according to the preset shortcut key TABLE.

Through the aforementioned shortcut key TABLE, the user can define the shortcut keys by the applications, thus improving the compilation efficiency.

According to aforementioned characteristics, the shortcut key's analog code refers to the internal code of shortcut keys preset by the application. The major advantages of the present invention are: with the shortcut key TABLE added in the present invention, the user-defined shortcut keys can be converted into the shortcut keys' internal code preset by the application, thus realizing the purposes of shortcut keys.

According to aforementioned characteristics, the processor-based system may be a PC, with its operating environment not limited in the present invention.

According to aforementioned characteristics, the user-defined key may be any key on the keyboard or the mouse; when the mouse is taken as an input source by the user-defined key, the relative displacement and vector of the mouse can be used as a source of user-defined key, in addition to the mouse's left, right or middle scroll buttons.

To make it easier for our examiner to understand the technical characteristics and effects of the present invention, we use preferred embodiments with accompanying drawings for the detailed description of the present invention as follows.

### BRIEF DESCRIPTION OF THE DRAWINGS

FIG. 1 is an operating process chart of previous input device and computer system;

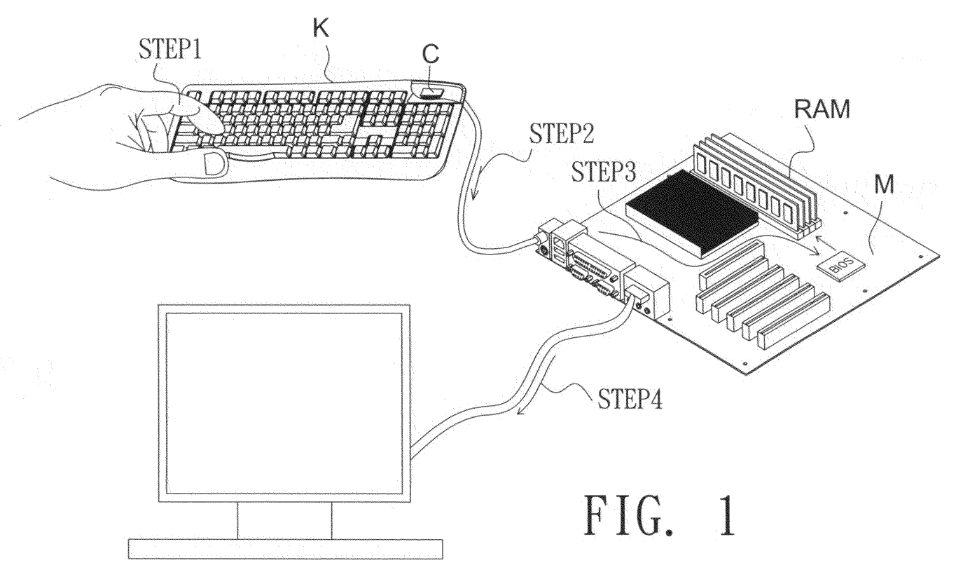

FIG. 2 is a flow process chart of previous input device and computer system;

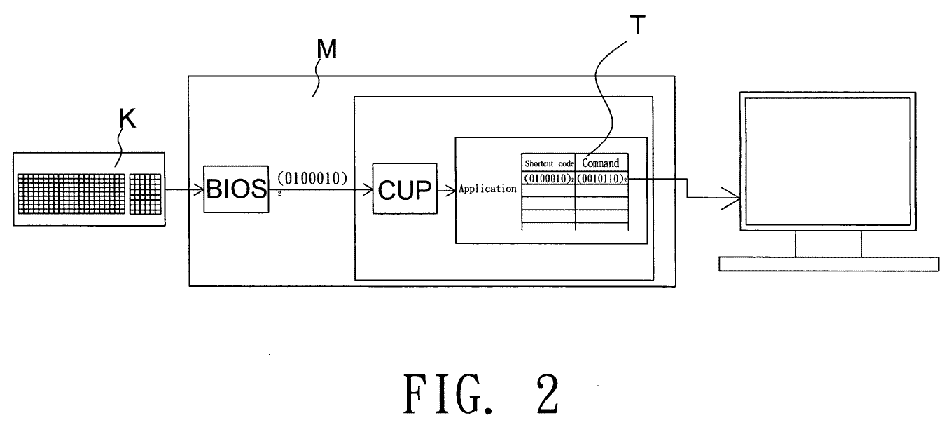

FIG. 3 is a schematic view of the methodology of the present invention for defining the shortcut key of input device;

FIG. 4 is a schematic view of the present invention that the method of defining the shortcut key of input device is applied to actual operation of the computer system;

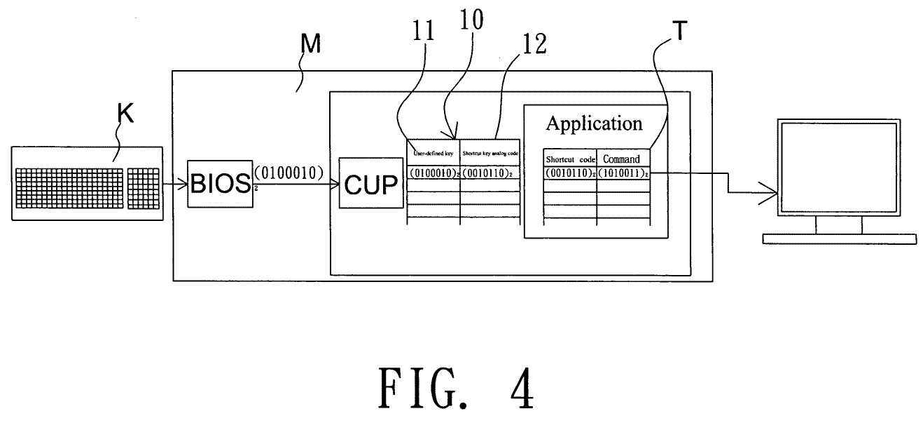

FIG. 5 is a view of the a program setting screen of the present invention for the method of defining the shortcut key of input device;

FIG. 6 is another view of the program setting screen of the present invention for the method of defining the shortcut key of input device;

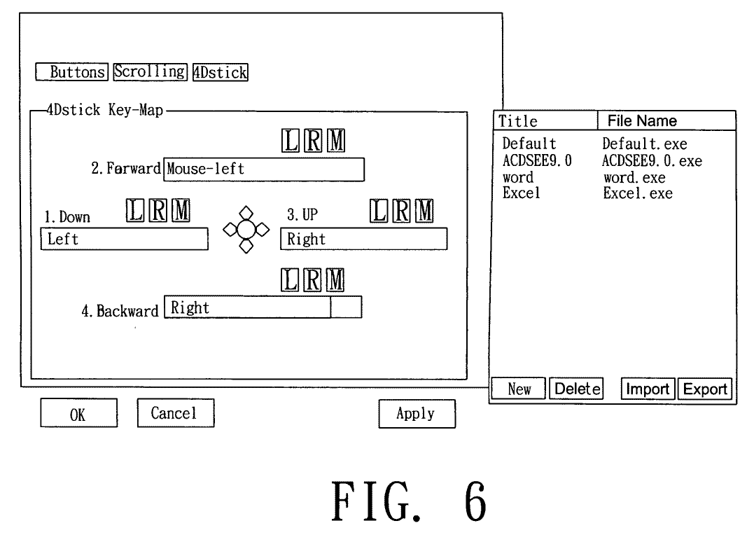

FIG. 7 is a status view of the present invention that multiple applications are operated by the same shortcut key and implemented by the fourth mouse key.

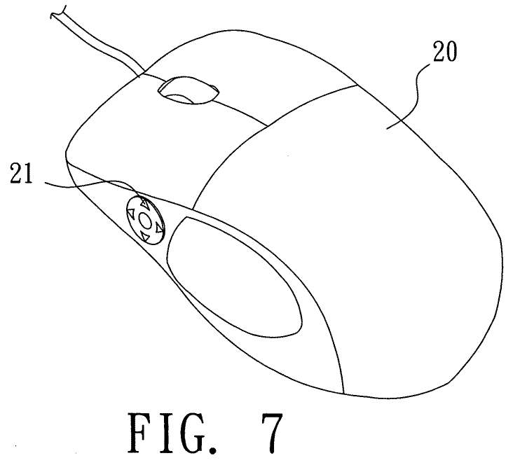

### DESCRIPTION OF THE PREFERRED EMBODIMENTS

The preferred embodiments are described by the mouse with a direction control panel (or a mouse with four direction keys), however, the input device of the present invention is not limited to such a mouse. In a broad sense, the input device of the present invention comprises: keyboard or common mouse; on a comparative basis, the user-defined key of the present invention may be any key on the keyboard (e.g.: F1 . . . F12 or CTRL).

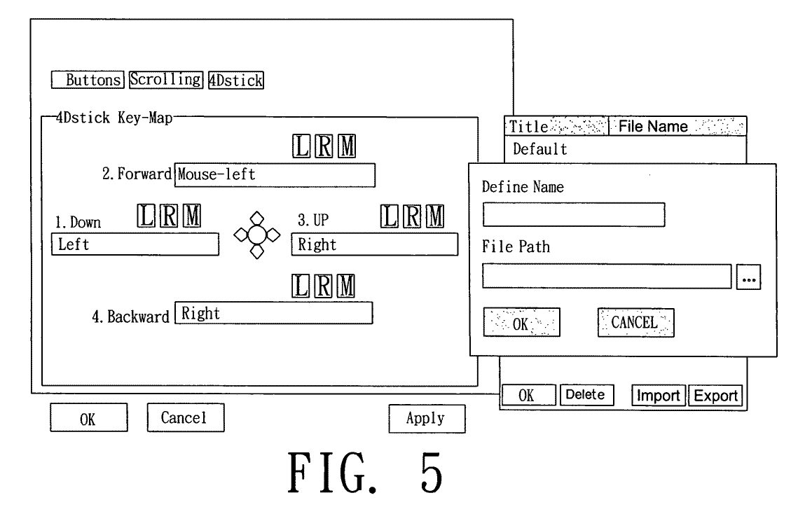

The present invention provides a method of defining the shortcut key of input device, whereby the user may define the contents of shortcut key according to its own operating practices. In the computer system with a central processor, some shortcut key TABLEs are predefined, each of which corresponds to the executable file (*.EXE) of an application; and, every TABLE is predefined with a user-defined key and corresponding shortcut key's analog code(i.e. internal code). As the mouse of the present invention is concerned, it is required to firstly add a corresponding shortcut key TABLE (shown in FIG. 5), and then set the user-defined keys and shortcut key analog codes in the TABLE; when the application is executed, the shortcut key TABLE, along with the executable program file, is loaded into RAM of the computer system (STEP 1); when the user enters the user-defined keys, the signals of the user-defined keys will be converted by BIOS into internal codes, and then output by the central processor according to the preset shortcut key analog code (STEP 2); this enables the central processor to enter corresponding commands and generate action according to the shortcut key TABLE preset by the application (STEP 3).

For example, if shortcut key TABLE of Application A is set in the preferred embodiment, the user-defined key is ↑ of mouse direction control panel, the internal code specific to ↑ corresponds to the shortcut key analog code, i.e. internal code of SPACE (U+0020); when application A is implemented, the shortcut key TABLE is loaded into the system simultaneously with Application A (STEP 1); when the user presses ↑ of direction control panel, the signal of ↑ is converted by BIOS into an internal code for the central processor, which outputs the corresponding shortcut key analog code (e.g. internal code of SPACE(U+0020)) (STEP 2) into the application according to the preset shortcut key TABLE; the application then inputs the corresponding command and then generates a SPACE (STEP 3).

In addition, there are also available with two or three groups of shortcut key analog codes in shortcut key TABLE, depending on the settings of shortcut key TABLE; for example: when the shortcut key preset by application is CTRL+P, two groups of shortcut key analog codes are required in shortcut key TABLE; as a general rule, since the shortcut key analog code of the present invention is an internal code of analog key, the shortcut key analog code is generally UNICODE code. In the present invention, this code is ASCII, ISO8859, EBCDIC or BIG5 code, depending on the internal code of the operating environment.

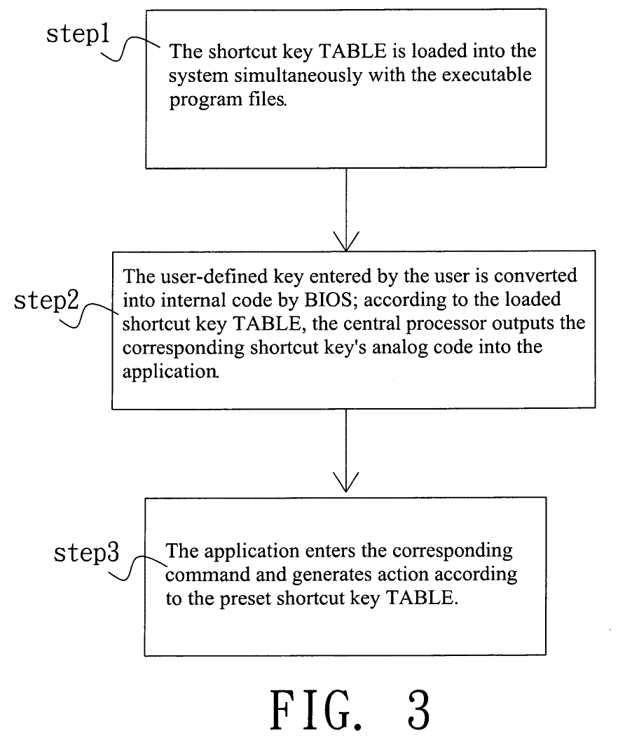

FIG. 3 depicts a status view of the present invention that multiple applications are operated by the same shortcut key and implemented by the fourth mouse key.

Referring to FIG. 3, the shortcut key of the present invention can be operated collaboratively or separately with keyboard and mouse 20; when a mouse 20 is only used by the shortcut key as an input source, the relative displacement and vector or shift track data of the mouse 20 can be used as a source of shortcut key, in addition to the mouse's left, right or middle scroll buttons as the user-defined key. The user-defined key of the shortcut key TABLE may be the displacement value or vector of the mouse, other than an internal code; for example, when the displacement of the mouse 20 from starting point to end point within a unit time is bigger or shorter than a certain distance, it corresponds to a shortcut key analog code of specific functions (e.g. PAGE UP or PAGE DOWN), alternatively, when the slope of the shift track of the mouse 20 exceeds a predefined value, it corresponds to a shortcut key analog code of cursor moving leftwards, otherwise, it corresponds to a shortcut key analog code of cursor moving rightwards.

While the invention has been described by means of specific embodiments, numerous modifications and variations could be made thereto by those skilled in the art without departing from the scope and spirit of the invention set forth in the claims.

What is claimed is:

1. A method of defining shortcut key of the input device, for a computer system with a central processor, this method provides several shortcut key TABLEs in advance, each of which corresponds to an application; every TABLE is predefined with a user-defined key and corresponding shortcut key's analog code; it comprises the following steps:
Step 1: the shortcut key TABLE is loaded into the system simultaneously with the executable program files;
Step 2: the user-defined key entered by the user is converted into internal code by BIOS; according to the loaded shortcut key TABLE, the central processor outputs the corresponding shortcut key's analog code into the application;
Step 3: the application enters the corresponding command and generates action according to the preset shortcut key TABLE.

2. The method of defining shortcut key of the input device according to claim 1, wherein the user-defined key may be any key on the keyboard or the mouse.

3. The method of defining shortcut key of the input device according to claim 1, wherein the user-defined key may be the relative displacement or vector of the mouse.

4. The method of defining shortcut key of the input device according to claim 1, wherein there are also available with two or more groups of shortcut key analog codes in the shortcut key TABLE.

5. The method of defining shortcut key of the input device according to claim 1, wherein the shortcut key analog code is UNICODE, ASCII, ISO8859, EBCDIC or BIG5 code, depending on the internal code of the system environment.
